(19) United States
(12) Patent Application Publication
(10) Pub. No.: US 2013/0073534 A1
(43) Pub. Date: Mar. 21, 2013

(54) METHOD OF SEARCHING RECORDED MEDIA CONTENT

(71) Applicant: Alex French, Norwood (AU)

(72) Inventor: Alex French, Norwood (AU)

(21) Appl. No.: 13/636,673

(22) PCT Filed: Mar. 24, 2011
(86) PCT No.: PCT/AU2011/000332

§ 371 Date: Dec. 3, 2012

(30) Foreign Application Priority Data
Mar. 24, 2010 (AU) 2010901318

(51) Int. Cl. G06F 17/30

(52) U.S. Cl. 707/706; 707/770; 707/E17.032; 707/E17.014

(57) ABSTRACT

In one aspect the invention provides a method of searching at least two sources of recorded media content accessible by a user, including the steps of, analysing a respective time coded transcript or time coded speech metadata, of said at least two sources of recorded media content to identify potentially relevant portions thereof based upon a search request from the user, access to the time coded transcript or time coded speech metadata, being controlled by a search provider, and displaying details of said potentially relevant portions, the user being able to select a portion or portions of the sources of recorded media content for review, wherein information regarding the portion or portions of recorded media content reviewed by said user, being sent to the search provider, a content provider or a third party.

### FIELD OF THE INVENTION

The present invention relates generally to providing a means of undertaking a search of a source of recorded media such as a multimedia presentation or audio recording, and in one aspect relates to searching of multiple sources of recorded media content to locate potentially relevant portions and reporting on the action taken by a user.

### BACKGROUND OF THE INVENTION

Recorded media are used regularly in business and education to present information as a teaching aid. As a result live presentations and talks are frequently recorded for viewing or to be listened to, at a later date. There are also available a range of video and/or audio presentations tailored around specific subject matters that are produced by a range of content providers.

The recorded media can be provided to the user on a storage device, such as a CD, or downloaded over the Internet. The user can purchase the recorded media and store the content on their personal computer or access the recorded media from a removable storage device.

The user may also be able to access recorded media over the Internet by way of a subscription. Typically this type of subscription lasts for a short period of time, such as 1 month. The recorded media is stored on a remote computer or server and the user can view or listen to the recording over the Internet using a temporary password and user name. After the set period of time the subscription must be renewed if the user wishes to review the recorded media.

A user may purchase many hours of recorded media on a particular subject matter. For instance a range of business packages are available from different content providers that assist in mentoring business owners and entrepreneurs. The content providers regularly update their material and expand their range of products to provide relevant subject matter to their customers.

There are systems suggested in paper publications that utilise a search of a transcript of a media presentation. However the existing methods do not include a feedback to enable analysis of the actual portions of recorded media content viewed by the user, or provide a means for searching a range of sources of media content accessible to the user.

It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

The phrase “search provider” is used throughout the specification to refer to the controller of the database that contains the transcripts of the recorded media content. The software program loaded onto the user's computer communicates with the search provider's computer system to undertake the steps of the invention. The phrase “content provider” is used throughout the specification to refer to the source of the recorded media content. There may be a number of content providers that utilise the same search provider or alternatively a content provider may also act as the search provider.

### SUMMARY OF THE INVENTION

In accordance with an aspect of the invention, but not necessarily the broadest or only aspect, there is proposed a method of searching at least two sources of recorded media content accessible by a user, including the steps of, analysing a respective time coded transcript or time coded speech metadata, of said at least two sources of recorded media content to identify potentially relevant portions thereof based upon a search request from the user, access to the time coded transcript or time coded speech metadata, being controlled by a search provider, and displaying details of said potentially relevant portions, the user being able to select a portion or portions of the sources of recorded media content for review, wherein information regarding the portion or portions of recorded media content reviewed by said user, being sent to the search provider, a content provider or a third party.

The details of said potentially relevant portions may include a corresponding link or hyperlink.

In one form the potentially relevant portions may include actual text from the time coded transcript or an indication that there is a positive hit on keywords entered by the user in the speech metadata.

The preceding method including the step of the user bookmarking the search results. If the user bookmarks search results based on the above method, the bookmarks are stored in a search results metadata database such that the searches being available and return text results to future searches conducted by said user or another user.

In one form the time coded transcript, or time coded speech metadata, are located on a database accessible by way of a computer network, preferably the Internet. The database may be in the form of metadata from the text transcript or speech analysis of recorded media content. The database may also include phonetic indexing data.

Multiple sources of recorded media content in different formats are searchable using the preceding method, including time coded transcript of audio or audio/visual recordings and speech analysis metadata of audio or audio/visual recordings. An advanced search option may enable a user to select specific packages, media or a particular content provider.

The recorded media content may be any media or multimedia recording, such as a presentation or lecture.

It is envisage that the playback of the media will be undertaken via the Internet using streaming servers. Users may be able to download media for playback on their local device after the search has been conducted. In another form the search is conducted of a user's media stored on a local hard-drive or removable storage device. For example a local database and platform-dependent application including the search capability may be provided.

The media content may be stored on the user's hard drive, removable storage device, or accessible by way of a computer network. The user may be prompted to insert the removable storage device or access an online subscription to review the recorded media content.

In one form a search request sent to the search provider includes information regarding all sources of recorded media content accessible by a user. The user may be viewing one source of recorded media content, such as a video of a seminar on a computer. The user's computer may also have stored on the hard drive additional sources of recorded media content, such as audio files and video or multimedia files. Furthermore, the user may have previously purchased and accessed other sources of media content on the computer that are stored on removable devices such as storage disks and details of which are retained by the computer's memory, cache or designated software.

The search provider's system may then analyse the time coded transcript or time coded speech metadata, of the source of recorded media content being currently accessed, as well as analysing time coded transcripts or time coded speech metadata, of each additional source of recorded media content previously viewed or accessed by the user.

The viewing or access information that is sent to the search provider enables improvements in the accuracy of future search results and demonstrates the portions of the media content that are being reviewed by users. This can provide information to the source of the media content regarding the information that users are interested in, which enables the content provider to modify or improve their products. The viewing or access information can also be used to market relevant products or services to the user. For instance other sources of media content can be offered for sale to a user depending upon their search request.

In another form the search provider may undertake a search of a third party record to present potentially relevant information. The third party record may be information obtained from the Internet using an existing search engine.

In yet another form the search provider may undertake a search of the user's computer to locate relevant previous searches or relevant bookmarks that have been created by the user. Bookmarks and search results may be stored online in a database or on the local PC of the user.

From the information regarding the portion of recorded media content reviewed by said user, the search provider may suggest other packages that may be of interest to the user and provide the option to purchase and/or download the media. The media offered can be printed media such as books and magazines, eBooks, streamed media, downloadable media and CD/DVDROM based media, based on what they search for and what they watch/listen. This enables a content provider to target their clients with content that is closely connected with their interests based on their exact usage.

Statistics on user searches and actual media content playback may be disclosed to the content providers to assist them with marketing and future content development.

The content provides may have access to statistics outlining the searches and playback of users accessing their content. They may “drill down” from top level summary statistics through to individual users. There may however be the option for the user to block this function on privacy grounds. Statistics include details of keyword searches, the media content viewed relating to each search, the links clicked and written feedback. The statistics may used by content providers to direct target marketing campaigns to the users, based on their interests and searches. The content provider may use the statistics to develop market analysis and to help them design new content.

In accordance with another aspect of the invention there is proposed a method of searching multiple sources of recorded media content accessible by a user, including the steps of,
a user submitting a search request to a search provider, the search request including at least one search term,
determining details regarding a first source of recorded media content currently being accessed by the user and details regarding at least one second source of recorded media content accessible by the user,
the search provider analysing a time coded transcript or time coded speech metadata, of the first source of recorded media content to identify potentially relevant portions based upon the search request submitted by a user,
the search provider analysing a time coded transcript or time coded speech metadata, of said at least one second source of recorded media content to identify potentially relevant portions based upon the search request submitted by a user,
access to said time coded transcripts or time coded speech metadata, being controlled by the search provider,
displaying to the user a first list with corresponding links to the potentially relevant portions of the first source of recorded media content, and
displaying to the user a second list with corresponding links to the potentially relevant portions of the second source or sources of recorded media content,
the user being able to select a corresponding link to access the recorded media content, wherein information regarding the portion of recorded media content viewed or accessed by said user, being sent to the search provider, a content provider or a third party, for analysis.

In the event that the second source of media content is stored on a removable device the user would be prompted to insert the relevant storage means.

The search request may also include details regarding sources of recorded media content that have previously be accessed by the user, for instance by way of a subscription. If the subscription is no longer current the search provider's system may prompt the user to resubscribe to access the media content.

The immediately preceding method including the step of search a database controlled by the search provider to identify comparable media content that is relevant to the search request and is not currently accessible to the user.

The search provider may provide limited access to the comparable media content or may provide a link to a website at which the media content can be purchased and/or downloaded.

Preferably the invention is performed using a designated computer program for controlling the operation of computing systems, environments, and/or configurations and for the application of the preceding methods. The computer program may be implemented as one or more modules for undertaking the steps of the present invention.

Computing systems, environments, and/or configurations that may be suitable for use with the invention include, but are not limited to, personal computers, portable media players, mobile telephones, microprocessor-based systems, set top boxes, programmable consumer electronics, minicomputers, hand-held device, laptops or any other system that is configured to store data and execute software.

The computer program preferably comprises program modules exactable by the computing device, wherein the computing device is directed by the program modules of the computer program to display a media viewing and searching system on the display screen of the computing device. The computer program generated display or window box on the user's computer may be separated into different sections to enable the viewing of multimedia presentations, searching of the content and display of various search results.

In one possible form the computer program generated display comprises a first section relating to presenting a source of media content and a second section for aiding in searching the media content being viewed and other media content accessible by the computing device. The second section includes a search request section for entering search criteria and a search results section for presenting the results of the search.

The user can enter a search term, terms or a phrase in the search request section. The computer program generated display or window box may further include a first search results section that displays the potentially relevant results of the search request for the current media content being accessed and a second search results section that displays the potentially relevant results of the search request for all other media content accessible by the user. The window box may also include a bookmark or previous search section that displays user's bookmarks or recent searches.

The computer is operated in a networked environment using logical connections to at least one remote computer, such as but not limited to a server or a networked computer. The communication between the computing system and the search provider may be to be via a communication interface using an appropriate communication channel such as a modem communication path, a telecommunication network, a local area network (LAN), a wide area network (WAN)/Internet or any other suitable network.

Appropriate security protocols and authentication may also be used to ensure secure communication between the user's computer and the search provider's computer.

The user's computer includes memory in the form of random access memory (RAM) and read-only memory (ROM), a central processing unit or units, input/output (IO) interfaces and at least one data storage device.

The foregoing is merely exemplary of relevant computing systems, environments, and/or configurations. Other computer systems may be practiced without departing from the scope of the invention. It should be appreciated that the invention may also include embedded software or firmware with corresponding hardware that is designed to perform one or more dedicated functions of the present invention.

### BRIEF DESCRIPTION OF THE DRAWINGS

The accompanying drawings, which are incorporated in and constitute a part of this specification, illustrate implementations of the invention and, together with the description and claims, serve to explain the advantages and principles of the invention. In the drawings:

FIG. 1 is a flow chart illustrating one embodiment of the steps of the present invention;

FIG. 2 is a schematic view of a user's computer in communication with a search provider's computer system; and

FIG. 3 is a possible layout of the window box displayed on a user's computer screen for facilitating a media content search.

### DETAILED DESCRIPTION OF THE ILLUSTRATED AND EXEMPLIFIED EMBODIMENTS

There are numerous specific details set forth in the following description. However, from the disclosure, it will be apparent to those skilled in the art that modifications and/or substitutions may be made without departing from the scope and spirit of the invention. In some circumstance specific details may have been omitted so as not to obscure the invention. Similar reference characters indicate corresponding parts throughout the drawings.

The reader should appreciate that time coding is a sequence of numeric codes generated at regular intervals by a timing system. Time codes are used extensively for synchronization, and for logging material in recorded media. The time codes may be linked to a transcript of a video or audio presentation. Alternatively the time codes may be linked to speech metadata produced from speech analysis using existing methods and software, or phonetic indexing data.

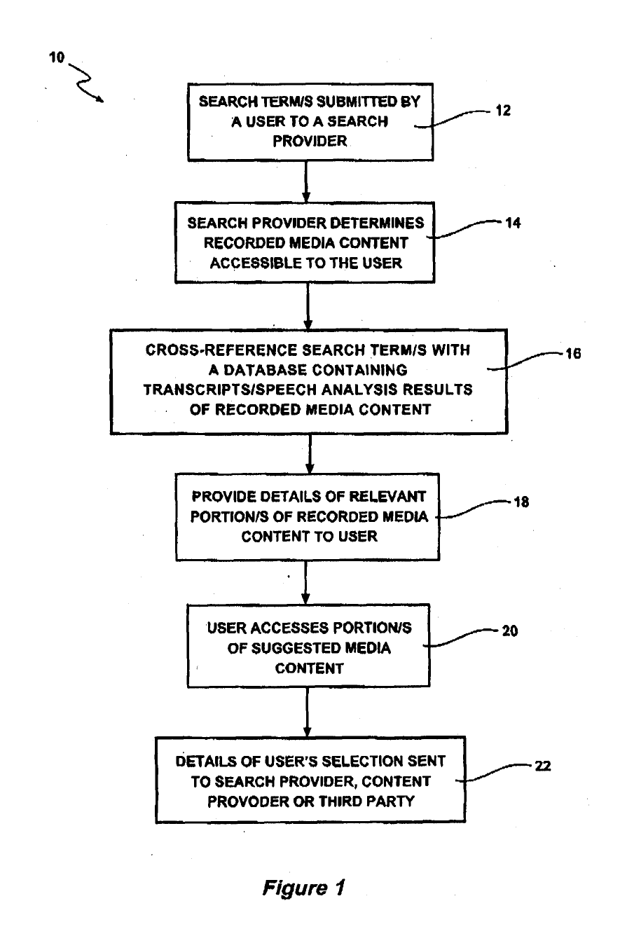

Referring to the drawings for a more detailed description, a method 10 of searching sources of recorded media content accessible by a user is illustrated, demonstrating by way of examples arrangements in which the principles of the present invention may be employed. FIG. 1 illustrates the method 10 of searching at least one source of recorded media content accessible by a user. The user submits a search request 12 in the form of a term or phrase. The search provider determines what recorded media is accessible by the user 14 and based upon the search request, undertakes analyses of a time coded transcript, or time coded speech metadata, of the source of recorded media content 16 to identify potentially relevant portions of the media content, access to the time coded transcript and time coded speech metadata, being controlled by a search provider. The search provider then supplies details of the potentially relevant portions to the user 18. The user is then able to select and access a portion or portions of the media content 20. Information regarding the portion/s of recorded media content reviewed by said user, are then sent to the search provider 22.

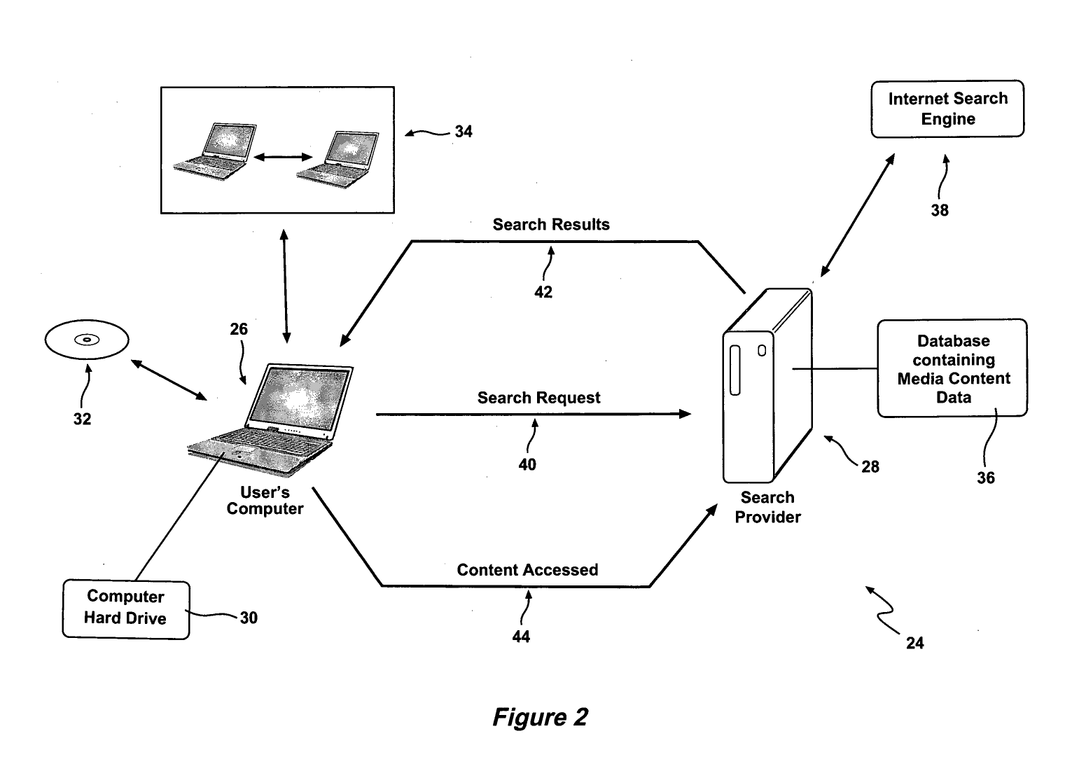

The method 10 is preferably a computer-implemented method that utilises designated software to undertake the above steps. FIG. 2 illustrates a computer environment 24 including a user's computer 26 and a search provider's computer system 28. The user's computer 26 has installed software for undertaking some of the steps of the invention.

The method 10 may be implemented using any suitable computing environment such as general purpose or special purpose computing system environments or configurations. Known computing systems, environments, and/or configurations that may be suitable for use with the invention include, but are not limited to, personal computers, portable media players, mobile telephones, microprocessor-based systems, set top boxes, programmable consumer electronics, minicomputers, hand-held device, laptops or any other system that is configured to store data and execute software.

The computer 26 includes memory in the form of random access memory (RAM) and read-only memory (ROM), a central processing unit or units, input/output (IO) interfaces and at least one data storage device, such as a hard drive 30. The computing device 26 may access various readable media both volatile and non-volatile, removable and non-removable media.

The computer 26 may be connectable to a removable data storage device 32 such as a magneto-optical disk storage, CD-ROM, digital versatile disc, magnetic tape, flash drive or other memory technology, computer readable card such as a PCMCIA card, magnetic storage device.

The user's computer 26 may also be in communication with the Internet 34 to access recorded media online through a subscription.

The communication between the computer 26 and the search provider's server 28 may be to be via a communication interface using an appropriate communication channel such as a modem communication path, a telecommunication network, a local area network (LAN), a wide area network (WAN)/Internet or any other suitable network.

The search provider's computer system 28 contains a database of the media content data 36 that corresponds to the recorded media content accessible by the user. The media content data 36 may be time coded transcript data, or other meta data that relates to the spoken word in the audio or video media, including phonetic indexing data. The search provider's computer system 28 is also in communication with the Internet via an Internet search engine 38 to undertake online searching for related products/services that can be promoted to the user.

As further illustrated in FIG. 2 the search request 40 is sent from the user's computer 26 to the search provider 28. The search request 40 including at least one search term and details regarding the recorded media content currently being accessed or viewed by the user and details regarding other sources of recorded media content that are accessible by the user's computer 26. The search provider 28 analysing a time coded transcript of the sources of recorded media content to identify potentially relevant portions based upon the search request submitted by a user. The search results 42 are sent to the user's computer 26 and the potentially relevant portions are displayed on the screen of the computer 26. The user selects and accesses a portion of the content and information regarding the portion of recorded media content accessed 44 by said user is sent to the search provider 28 for analysis.

The computer program preferably comprises program modules exactable by the computing device, wherein the computing device 26 is directed by the program modules of the computer program to display a media viewing and searching system on the display screen of the computing device 26. The computer program generated display comprises a first section relating to presenting a media content and a second section for aiding in searching the media content being viewed and other media content accessible to the computing device 26. The second section includes a search request section for entering search criteria and a search results section for presenting the results of the search.

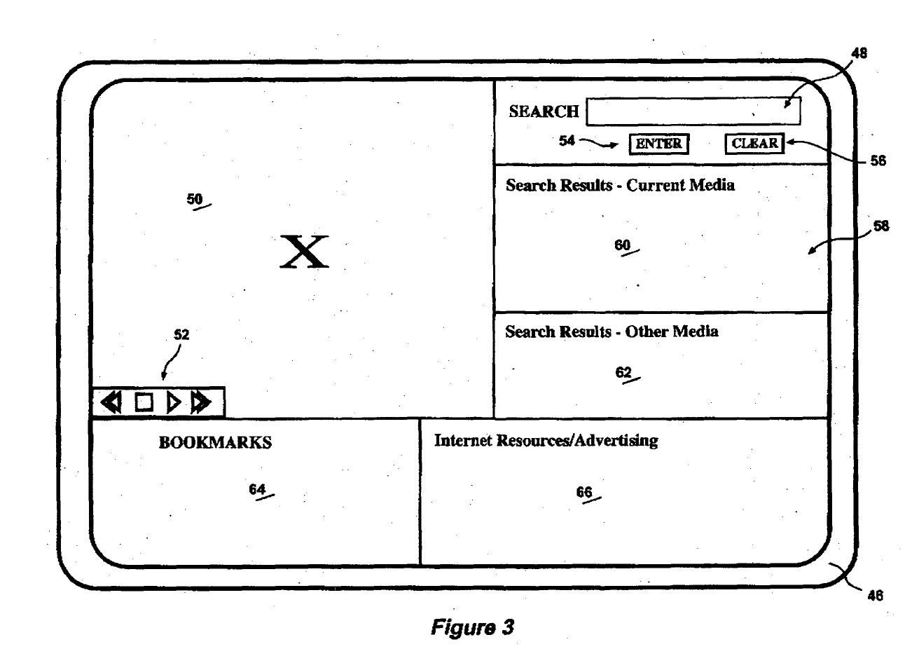

FIG. 3 illustrates a possible layout of the window box 46 displayed on the user's computer 26. The computer program displays the search request section 48 alongside the media content presenting section 50. The media can be either audio/video or audio media and section 50 may include a control bar 52 including a stop, play, forward and rewind button as is known in conventional media players. The search request section 48 includes an enter button 54 and clear button 56 for undertaking a search. The display 46 also includes a search results section 58. If there is not enough space in the search results section a slide bar (not shown) may be presented for viewing all of the results. The user can select the clear button 56 at any point in the search process after having entered all or part of a search request. When the clear button 56 is activated, all the search spaces are cleared and ready for a new request.

The search request section 47 may also include advance search options (not shown) that can be used to tailor the search to the user's requirements.

In use a user enters keywords in the search request section 48 and selects the enter button 54. The search request 40 is sent to the search provider's computer 28 and the keywords matched with a portion or portions of the transcript text that corresponds to the media being presented in the presentation section 50. Furthermore details regarding other media content accessible by user's computer are also sent to the search provider's server 28. A search is then undertaken of the transcripts that corresponds to these other sources of media content accessible by the user's computer 26.

The search results 42 are sent back to the user's computer 26 and displayed in section 58. The search results 42 are displayed as a list, with corresponding links, of phrases from the time coded transcript or transcripts containing the keyword/s entered or similar phrases.

The search results section 58 may be divided into a number of sections. A first section 60 displays a list comprising the portion or portions of the current media being presented in the presentation section 50 containing the text entered by the user. The second section 62 displays a list comprising the portion or portions contained within other media presentations available to the user. As the reader will now appreciate the other media presentations may be already loaded onto the computer/media player or contained on removable storage devices such as CD's or DVD's.

It should be appreciated that a smart text function may be used wherein as the user enters each letter, number or symbol into the search request portion, the closest fitting relevant portion/s within the source of media content or previous search requests are displayed in the search request section.

The user may then select one of the listed search results 42. It should be appreciated that if the list of phrases containing the keyword exceeds the space available in the display section the user can scroll through the list by way of a slider bar (not shown) provided to the side of the search results section.

The method may incorporate known methods of selecting an entry in a list wherein the user may either single or double click the associated link. If the user single clicks the link additional information about the subject can be displayed in a secondary window. If the link is double clicked the relevant media presentation will start in the display section at the point corresponding to the transcript unit containing the selected search link. Alternatively moving the pointer over the link can activate a popup window that displays additional information.

The search results 42 may be sorted using various known method including sorting by relevance, last date accessed, date of creation or any other parameter. The search results may also be presented in various formats for instance the search results may present identical word or phrase results as well as subject or title results. The subject or title results relate to subject headings that may be relevant to the search request. The subject or title results are assigned an elapsed running time of the video or audio that corresponds to the beginning of the portion of the program relating to that topic.

The invention may include the function of bookmarking a selected portion or portions of the media content for future reference. Accordingly a bookmark section 64 is provided in the display window 46. Bookmarking allows a user to make a list of parts of the media presentation that the user would like ready access to in the future. The bookmark list created by the user is a list of content topics corresponding to the portions of the media presentation concerning particular topics.

The computer program generated display may therefore include a bookmarks section that may remain blank until the user creates personalised bookmarks using an add bookmarks button (not shown). Alternatively the computer program may generate a suggested list of bookmarks. Any number of bookmarks can be created and accordingly if the list becomes too long to be displayed in its entirety a slider can be provided. The bookmark section may include add, remove and modify buttons for organising and personalising the bookmarks.

There are many advantages with the illustrated invention. The invention enhances the user's experience by enabling them to bookmark and quickly access the content that is of particular interest to them.

The user can furthermore perform keyword searches on many hundreds or thousands of hours of audio and video material, avoiding the need to play back complete packages to find what they are looking for, thereby saving the user time.

The search provider may suggest other packages that may be of interest to the user and provide the option to instantly purchase and/or download the media. The media offered can be printed media, downloadable media and CD/DVDROM based media, based on what they search for and what they watch/listen. This enables a content provider to target their clients with content that is closely connected with their interests based on their exact usage. Accordingly, the display window 46 includes a resource/advertising section 66.

There is also provided the opportunity for instant marketing, including special offers and standard packages, based on what the user searched for and what they watch/listen to and, therefore, the topics of specific interest to them that can be displayed in section 66.

The method provides statistics on user searches and actual media content playback to the content providers to assist them with marketing and future content development.

The software is a cross-platform [PC and MAC] browser-based software application that utilizes an online database and both locally stored [offline] and online multimedia/media delivery.

The system works with both the user's existing multimedia presentations [on CD or DVD] and also with file-based media which can be supplied to them through a download from a website and also by sending packages to them on CD/DVDROM and as printed media.

The reader should appreciate that the transcript of the recorded media content may be created in real time, whereby an instant transcript is produced of the multimedia presentation as it is being recorded in a live environment, for example, a seminar. Alternatively the content provider/search provider may supply a transcript of the presentation or a transcript of the recording may be created in an offline process.

In one embodiment chunking of the transcript text into sentences and/or phrases is undertaken and the transcript is then time coded so that the start and end of each sentence can be synchronized to the audio/video in the multimedia recordings. It should however be appreciated that other types of type coding could be used.

The time coded transcript is then uploaded to the search provider's database, tagging each sentence with metadata including the start and end times, the content provider, subject, media name, content package name and any additional keywords which might be applicable. The content provider/search provider may also add to the power keywords at any time by doing their own advanced keyword searches.

The user can perform keyword searches on the online database, based on filters such as “only the current media or package” and “only the current content provider”.

Information about the user's locally stored content may be uploaded to the online database when they copy it to their hard drive and when they insert it into the DVD drive, i.e. the search provider knows what content the user already owns and, therefore, the future marketing can be highly targeted.

The software application can play video/audio from the local hard drive and it can download media from a web server. The application is able to determine which media is playing and records the start and end points of each “playback” into an online database.

Search results also include other multimedia content, so the user can have suggestions presented to them as to where else they can find content that relates to their query.

Content provides have access to statistics outlining the searches and playback of users of their content. They can “drill down” from top level summary statistics through to individual users. There may however be the option for the user to block this function on privacy grounds. Statistics include details of keyword searches, the multimedia content viewed relating to each search, the links clicked and written feedback. The statistics can be used by content providers to direct target marketing campaigns to the users, based on their interests and searches. The statistics can also be used by the content provider to develop market analysis to help them to design their new content.

Content providers can restrict some content so that it is available only to restricted user groups. This can be used to trial new content and obtain feedback from some users before making the material available to all users. Content providers can choose whether to allow users to provide feedback on their material that is accessible to other users.

It is envisage that use of the software application is provided on the basis of annual membership subscriptions. Subscriptions may be sold to the content provider or directly to end users.

It is envisage that the media content will be played off the local hard drive of the user's computer or off the original CD/DVD. Content downloaded from the website to the local hard drive is copy protected. This protects the content provider's copyright by only allowing the paid-up member to login and access the content.

The skilled addressee will now appreciate the many advantages of the illustrated invention over the prior art. The method can be used to search video or audio content online, including audio books, eBooks, educational material, professional speaker's material who sell recorded product, internet marketers or any video or audio content published in electronic format that can be analysed to produce a time coded transcript or speech metadata.

Various features of the invention have been particularly shown and described in connection with the exemplified embodiments of the invention, however, it must be understood that these particular arrangements merely illustrate and that the invention is not limited thereto. Accordingly the invention can include various modifications, which fall within the spirit and scope of the invention. It should be further understood that for the purpose of the specification the word “comprise” or “comprising” means “including but not limited to”.

The claims defining the invention are as follows:

1. A method of searching at least two sources of recorded media content accessible by a user, including the steps of, analysing a respective time coded transcript or time coded speech metadata, of said at least two sources of recorded media content to identify potentially relevant portions thereof based upon a search request from the user, access to the time coded transcript or time coded speech metadata, being controlled by a search provider, and displaying details of said potentially relevant portions, the user being able to select a portion or portions of the sources of recorded media content for review, wherein information regarding the portion or portions of recorded media content reviewed by said user, being sent to the search provider, a content provider or a third party.

2. The method in accordance with claim 1 wherein the details of said potentially relevant portions may include a corresponding link or hyperlink.

3. The method in accordance with claim 1 or 2 wherein the potentially relevant portions may include actual text from the time coded transcript or an indication that there is a positive hit on keywords entered by the user in the speech metadata.

4. The method in accordance with any one of claims 1 to 3 including the step of the user bookmarking search results, wherein the bookmarks are stored in a search results metadata database such that said results being available for future searches.

5. The method in accordance with any one of the above claims wherein the time coded transcript or time coded speech metadata, are located on a database accessible by way of a computer network, including the Internet.

6. The method in accordance with any one of the above claims wherein multiple sources of recorded media content stored in different formats are searchable.

7. The method in accordance with any one of the above claims wherein a user can select specific packages, media or a particular content provider to be searched.

8. The method in accordance with any one of the above claims wherein playback of the media may be undertaken via the Internet using streaming servers.

9. The method in accordance with any one of the above claims wherein the user can download media for playback onto their local storage device after the search has been conducted.

10. The method in accordance with any one of claims 1 to 7 wherein the search is conducted of a user's local media or local database using a platform-dependent software application.

11. The method in accordance with any one of claims 1 to 7 wherein the media content may be stored on a removable storage device, the user being prompted to insert said removable storage device to review the recorded media content.

12. The method in accordance with any one of the above claims wherein a search request sent to the search provider includes information regarding all sources of recorded media content accessible by a user.

13. The method in accordance with any one of the above claims wherein the search provider's system may analyse a time coded transcript or time coded speech metadata, of the source of recorded media content being currently accessed, as well as analysing time coded transcripts or time coded speech metadata, of each additional source of recorded media content previously viewed or accessed by the user.

14. The method in accordance with any one of the above claims wherein the search provider may undertake a search of a third party record to present potentially relevant information, the third party record being information obtained from the Internet using an existing search engine.

15. The method in accordance with any one of the above claims wherein the search provider may undertake a search of the user's computer to locate relevant previous searches or relevant bookmarks that have been created by the user.

16. The method in accordance with claim 15 wherein bookmarks and search results may be stored online in a database or on the local storage device of the user.

17. The method in accordance with any one of the above claims wherein statistics on a user's search and actual media content playback are disclosed to the content providers or third parties.

18. A method of searching multiple sources of recorded media content accessible by a user, including the steps of,
a user submitting a search request to a search provider, the search request including at least one search term,
determining details regarding a first source of recorded media content currently being accessed by the user and details regarding at least one second source of recorded media content accessible by the user,
the search provider analysing a time coded transcript or time coded speech metadata, of the first source of recorded media content to identify potentially relevant portions based upon the search request submitted by a user,
the search provider analysing a time coded transcript or time coded speech metadata, of said at least one second source of recorded media content to identify potentially relevant portions based upon the search request submitted by a user,
access to said time coded transcripts or time coded speech metadata, being controlled by the search provider,
displaying to the user a first list with corresponding links to the potentially relevant portions of the first source of recorded media content, and
displaying to the user a second list with corresponding links to the potentially relevant portions of the second source or sources of recorded media content,
the user being able to select a corresponding link to access the recorded media content, wherein information regarding the portion of recorded media content viewed or accessed by said user, being sent to the search provider, a content provider or a third party, for analysis.

19. The method in accordance with claim 18 wherein the second source of media content is stored on a removable device, the user being prompted to insert the relevant storage means, or the second source of media content is stored on a server accessible via an computer network, or the second source of media content is a lapsed subscription wherein the user being prompted to resubscribe to access the media content.

20. The method in accordance with any one of the above claims wherein some of the steps are performed using a designated computer program for controlling the operation of computing systems, environments, and/or configurations and for the application of the preceding methods, the computer program being implemented as one or more modules for undertaking any one of the above steps.
